(19) United States
(12) Patent Application Publication
(10) Pub. No.: US 2025/0019046 A1
(43) Pub. Date: Jan. 16, 2025

(54) SKIDDING SYSTEM AND A METHOD OF OPERATING THE SKIDDING SYSTEM

(71) Applicant: IQIP Holding B.V., Sliedrecht (NL)

(72) Inventors: Quintus Wilhelmus Petrus Maria Zuijdgeest, Zoetermeer (NL); Marius Peerdeman, Gorinchem (NL)

(21) Appl. No.: 18/778,711

(22) Filed: Jul. 19, 2024

Related U.S. Application Data
(63) Continuation of application No. PCT/NL2023/050015, filed on Jan. 17, 2023.

(30) Foreign Application Priority Data
Jan. 21, 2022 (NL) 2030636

(51) Int. Cl. B63B 25/00

(52) U.S. Cl. CPC B63B 25/004

(57) ABSTRACT

A skidding system for skidding a heavy load over a deck of a vessel includes a hydraulic cylinder cooperates with a skid shoe and the load to be displaced with respect to a skid rail along a line of displacement. The hydraulic cylinder extends to displace the load when the skid shoe is locked with respect to the skid rail. A skid shoe displacement device moves the shoe with respect to the rail in the same direction along the line of displacement when the shoe is unlocked from the rail. A first releasable coupling couples a piston rod to the load. A second releasable couples a cylinder body to the skid shoe. A third releasable coupling couples the cylinder body to the load to be displaced with respect to the skid rail along the line of displacement, while a fourth couples the piston rod to the skid shoe.

### CROSS-REFERENCE TO RELATED APPLICATION

This Application is a continuation of International Application No. PCT/NL2023/050015, filed Jan. 17, 2023 and claims priority of Netherlands Patent Application 2030636, filed Jan. 21, 2022, the contents of both of which are incorporated by reference in their entirety.

### BACKGROUND

The discussion below is merely provided for general back-ground information and is not intended to be used as an aid in determining the scope of the claimed subject matter.

The present invention relates to a skidding system for skidding a heavy load over a deck of a vessel, comprising a skid shoe, a skid rail for guiding the skid shoe along a line of displacement, a skid shoe lock for locking the skid shoe with respect to the skid rail, a hydraulic cylinder being configured to cooperate with the skid shoe and a load to be displaced with respect to the skid rail along the line of displacement, which hydraulic cylinder comprises a cylinder body and a piston rod that is extendable with respect to the cylinder body by hydraulic power so as to displace the load with respect to the skid rail in a direction along the line of displacement when the skid shoe is locked with respect to the skid rail and a skid shoe displacement device for moving the skid shoe with respect to the skid rail in the same direction along the line of displacement when the skid shoe is unlocked with respect to the skid rail.

Such a skidding system is known in the prior art. Skidding of a load is performed by means of a double acting hydraulic cylinder that skids the load in a series of short steps, between which the piston rod is retracted in the cylinder for the next stroke. When skidding the load in one direction along the line of displacement the skid shoe is temporarily locked with respect to the skid rail by means of the skid shoe lock and the piston rod is extended in order to displace the load, after which the skid shoe lock is unlocked and the piston rod is retracted in order to pull the skid shoe towards the load. It is not necessary to lock the load to the deck during displacement of the skid shoe along the skid rail since the friction between the load and its support is much higher than the friction between the skid shoe and the skid rail. When skidding the load in opposite direction the skid shoe is also temporarily locked with respect to the skid rail by means of the skid shoe lock, but the piston rod is retracted in order to displace the load, after which the skid shoe lock is unlocked and the piston rod is extended in order to push the skid shoe away from the load. In other words, in the latter case the hydraulic piston pulls the load by retracting the piston rod.

A disadvantage of the known skidding system is that a higher hydraulic pressure must be supplied to the hydraulic cylinder in order to generate a certain pulling force on the load than to generate a pushing force of the same magnitude. This is caused by the presence of the piston rod at one side of a piston which is located at the end of the piston rod in the cylinder body, which leads to a smaller surface on which hydraulic pressure is applied than at the opposite side of the piston.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in deter-mining the scope of the claimed subject matter. The claimed subject matter is not limited to implementations that solve any or all disadvantages noted in the Background.

A skidding system disclosed herein includes a first releasable coupling for coupling the piston rod to the load to be displaced with respect to the skid rail along the line of displacement, a second releasable coupling for coupling the cylinder body to the skid shoe, a third releasable coupling for coupling the cylinder body to the load to be displaced with respect to the skid rail along the line of displacement and a fourth coupling for coupling the piston rod to the skid shoe.

When the first and second couplings are activated, the third and fourth couplings are de-activated and the skid shoe lock is activated the load is pushed by the piston rod of the hydraulic cylinder during extending the piston rod. When the third and fourth couplings are activated, the first and second couplings are de-activated and the skid shoe lock is activated the load is pulled by the cylinder body of the hydraulic cylinder during extending the piston rod. Hence, both the pushing action and the pulling action is performed by extending the piston rod, which is advantageous because of the relative high ratio between the generated force and supplied hydraulic pressure that can be achieved.

In an embodiment each of the second and fourth couplings comprises a locking element and an actuator for activating the locking element, which actuator is mounted to the skid shoe. The actuators may be controlled manually or automatically, for example by means of an electric or hydraulic system.

The locking elements of the second and fourth couplings may comprise respective pins which are movable in their longitudinal directions by the corresponding actuators. This is a relatively simple manner of coupling parts to each other.

The pin of the second coupling may fit in cooperating holes of the skid shoe and the cylinder body so as to lock them to each other and the pin of the fourth coupling may fit in cooperating holes of the skid shoe and the piston rod so as to lock them to each other.

In a particular embodiment the skidding system is provided with a skid frame which is configured to be coupled to a load to be displaced with respect to the skid rail along the line of displacement, wherein each of the first and third couplings comprises a locking element and an actuator for activating the locking element, which actuator is mounted to the skid frame. The actuators may be controlled manually or automatically, for example by means of an electric or hydraulic system.

The locking elements of the first and third couplings may comprise respective pins which are movable in their longitudinal directions by the corresponding actuators.

The pin of the first coupling may fit in cooperating holes of the skid frame and the piston rod so as to lock them to each other and the pin of the third coupling may fit in cooperating holes of the skid frame and the cylinder body so as to lock them to each other.

It is noted that the first coupling and the third coupling could be activated simultaneously but in that case no skidding is possible.

In an embodiment the holes for receiving the pins of the second and third couplings are located at the same location of the cylinder body as seen in longitudinal direction of the hydraulic cylinder and the holes for receiving the pins of the first and fourth couplings are located at the same location of the piston rod as seen in longitudinal direction of the hydraulic cylinder. This provides the opportunity to make a compact skidding system.

The holes at the piston rod may intersect each other and/or the holes at the cylinder body may intersect each other. The pins of the first and fourth couplings will not obstruct each other since they are not inserted into the piston rod at the same time. Similarly, the pins of the second and third couplings will not obstruct each other since they are not inserted into the cylinder body at the same time.

In a robust embodiment the skid frame surrounds the hydraulic cylinder and is supported by the skid shoe, wherein the skid frame is movable with respect to the skid shoe in the direction along the line of displacement and provided with slotted holes extending along the line of displacement for allowing a movement of the skid frame with respect to the skid shoe in the event that the pin of the second coupling is located in the corresponding hole in the skid shoe, the corresponding slotted hole in the skid frame and the corresponding hole in the cylinder body or in the event that the pin of the fourth coupling is located in the corresponding hole in the skid shoe, the corresponding slotted hole in the skid frame and the corresponding hole in the piston rod.

In a preferred embodiment the hydraulic cylinder is a double acting hydraulic cylinder, wherein the piston rod is retractable with respect to the cylinder body by hydraulic power, hence forming the skid shoe displacement device.

Alternatively, the skid shoe displacement device may comprise a spring which is functionally coupled to the hydraulic cylinder and the skid shoe such that the spring is biased upon extending the piston rod with respect to the cylinder body. After the load has been moved by activating the hydraulic cylinder the skid shoe can be displaced with respect to the skid rail in the same direction as the load by means of spring force from the biased spring after unlocking the skid shoe lock from the skid rail and stopping supply of hydraulic power to the hydraulic cylinder. The spring force may also be used to move the extended piston rod back to its retracted position together with displacing the skid shoe.

The invention is also related to a method of operating the skidding system as described hereinbefore, wherein the piston rod is coupled to a load by the first coupling and the cylinder body is coupled to the skid shoe by the second coupling, whereas the third and fourth couplings are left in de-coupled conditions, wherein first the skid shoe is locked to the skid rail by the skid shoe lock and the piston rod is in a retracted condition, and then the hydraulic cylinder is controlled such that the piston rod is extended so as to move the load with respect to the skid rail in a direction along the line of displacement, and subsequently the skid shoe lock is unlocked so as to move the skid shoe with respect to the skid rail in the same direction along the line of displacement by the skid shoe displacement device. In this case the load may be pushed away from the skid shoe upon extending the piston rod, whereas the skid shoe may be pulled towards the load by the skid shoe displacement device.

In an alternative embodiment the cylinder body is coupled to a load by the third coupling and the piston rod is coupled to the skid shoe by the fourth coupling, whereas the first and second couplings are left in de-coupled conditions, wherein first the skid shoe is locked to the skid rail by the skid shoe lock and the piston rod is in a retracted condition, and then the hydraulic cylinder is controlled such that the piston rod is extended so as to move the load with respect to the skid rail in a direction along the line of displacement, and subsequently the skid shoe lock is unlocked so as to move the skid shoe with respect to the skid rail in the same direction along the line of displacement by the skid shoe displacement device. In this case the load may be pulled towards the skid shoe upon extending the piston rod, whereas the skid shoe may be pulled away by the skid shoe displacement device.

### BRIEF DESCRIPTION OF THE DRAWINGS

Aspects of the invention will hereafter be elucidated with reference to the schematic drawings showing an embodiment of the invention by way of example.

FIG. 1 is a perspective view of an embodiment of a skidding system.

FIG. 2 is an illustrative view of conditions of the skidding system as shown in FIG. 1 in an operating mode.

FIG. 3 is a similar view as FIG. 2, but showing a different operating mode.

FIG. 4 is a similar view as one of the pictures of FIG. 2, illustrating an alternative embodiment.

### DETAILED DESCRIPTION OF THE ILLUSTRATIVE EMBODIMENTS

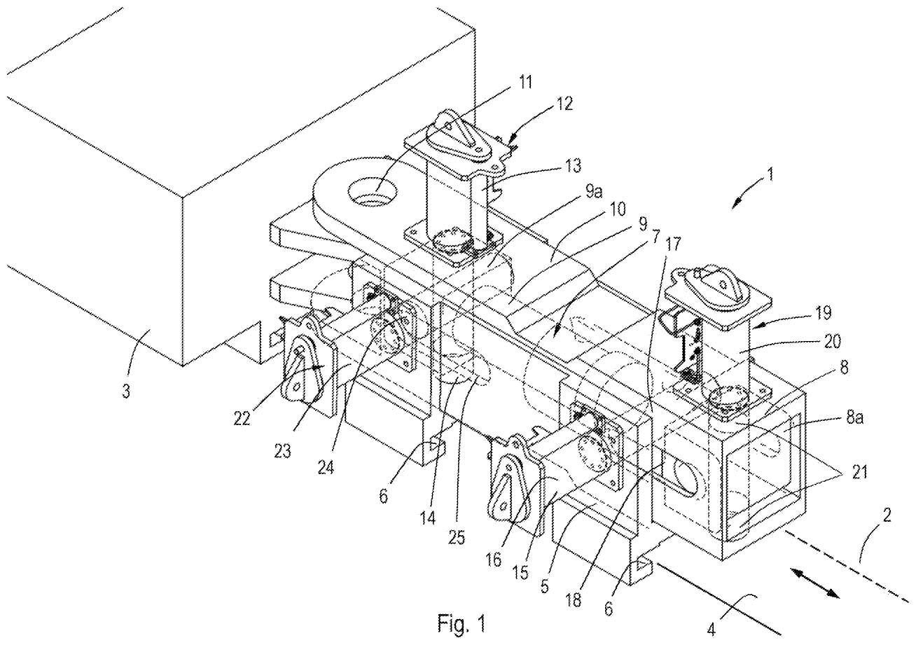

FIG. 1 shows an embodiment of a skidding system 1. The skidding system 1 is located on a deck 2 of a vessel (not shown) and serves to move a heavy load over the deck 2, for example a monopile.

The skidding system 1 comprises an elongated skid rail 4 which is fixed to the deck 2. A skid shoe 5 is mounted to the skid rail 4 and guidable along the skid rail 4 along a line of displacement X. The skid shoe 5 is displaceable along the skid rail 4 in opposite directions as shown by a double-headed arrow in FIG. 1. The skid shoe 5 comprises a U-shaped beam which is provided with four sliders 6 at the bottom thereof, which sliders 6 are in engagement with the skid rail 4. The sliders 6 are provided with skid shoe locks (not shown) for locking the skid shoe 5 with respect to the skid rail 4 in longitudinal direction of the skid rail 4. FIG. 1 shows that the load 3 is also provided with a slider which is guidable by the skid rail 4, but it may also be guided by a separate guide in an alternative embodiment.

The skidding system 1 is further provided with a double acting hydraulic cylinder 7 including a cylinder body 8 and a piston rod 9. The piston rod 9 is extendable and retractable with respect to the cylinder body 8 in a well-known manner. The hydraulic cylinder 7 is accommodated in and supported by a skid frame 10. In this case the skid frame 10 has a substantially tubular shape including a square cross-section and surrounds the hydraulic cylinder 7. The cylinder body 8 has a block-shaped sliding portion 8a and the piston rod 9 has a block-shaped sliding portion 9a. Outer sides of the respective sliding portions 8a, 9a have square cross-sections and fit inside the skid frame 10. Hence, the hydraulic cylinder 7 is supported and guidable by the skid frame 10.

The skid frame 10 fits within the U-shaped beam of the skid shoe 5. A lower side of the skid frame 10 rests on a bottom of the U-shaped beam of the skid shoe 5. An upper side of the skid frame 10 is provided with a coupling eye 11 for coupling the skid frame 5 to the load 3, for example by putting a pin through the coupling eye 11 and a cooperating coupling eye of the load 3.

The skidding system 1 is provided with a first releasable coupling 12 for coupling the piston rod 9 via the skid frame 10 to the load 3. The first coupling 12 comprises a hydraulic actuator 13 and a pin 14 which can be displaced by the hydraulic actuator 13 through fitting through-holes in the skid frame 10 and the sliding portion 9a of the piston rod 9 into a fitting hole in a bottom wall of the skid frame 10. The hydraulic actuator 13 of the first coupling 12 is mounted to the skid frame 10 at an upper side thereof.

The skidding system 1 is also provided with a second releasable coupling 15 for coupling the cylinder body 8 to the skid shoe 5. The second coupling 15 comprises a hydraulic actuator 16 and a pin 17. The hydraulic actuator 16 of the second coupling 15 is mounted to an outer side of the U-shaped beam of the skid frame 10. The pin 17 can be displaced by the hydraulic actuator 16 through a fitting through-hole in one of the upright webs of the U-shaped beam of the skid shoe 5, a first slotted hole 18 in one of the side walls of the skid frame 10 extending parallel to the line of displacement X, a fitting through-hole in the sliding portion 8a of the cylinder body 8, a second slotted hole in an opposite side wall of the skid frame 10 extending parallel to the first slotted hole 18 and a fitting hole in an opposite upright web of the U-shaped beam of the skid shoe 5.

The skidding system 1 is provided with a third releasable coupling 19 for coupling the cylinder body 8 via the skid frame 10 to the load 3. The third coupling 19 comprises a hydraulic actuator 20 and a pin 21, which can be moved by the hydraulic actuator 20 through fitting through-holes in the skid frame 10 and the sliding portion 8a of the cylinder body 8 into a fitting hole in a bottom wall of the skid frame 10. The hydraulic actuator 20 of the third coupling 19 is mounted to the skid frame 10 at an upper side thereof and at a distance of the hydraulic actuator 13 of the first coupling 12.

The skidding system 1 is also provided with a fourth releasable coupling 22 for coupling the piston rod 9 to the skid shoe 5. The fourth coupling 22 comprises a hydraulic actuator 23 and a pin 24 which can be moved by the hydraulic actuator 23 through a fitting through-hole in one of the upright webs of the U-shaped beam of the skid shoe 5, a third slotted hole 25 in one of the side walls of the skid frame 10 extending parallel to the line of displacement X, a fitting through-hole in the sliding portion 9a of the piston rod 9, a fourth slotted hole in an opposite side wall of the skid frame 10 extending parallel to the third slotted hole 25 and a fitting hole in an opposite upright web of the U-shaped beam of the skid shoe 5. The hydraulic actuator 23 of the fourth coupling 22 is mounted to an outer side of the U-shaped beam of the skid frame 10 at the same side as the hydraulic actuator 16 of the second coupling 15.

When the first to fourth couplings 12, 15, 19, 22 are decoupled the skid frame 10 is displaceable with respect to the skid shoe 5 along the line of displacement X and the hydraulic cylinder 7 is movable with respect to the skid frame 10 along the line of displacement X.

In the embodiment as shown in FIG. 1 the holes for receiving the pins 17, 21 of the second and third couplings 15, 19 are located at the same location of the cylinder body 8 as seen in longitudinal direction of the hydraulic cylinder 7. Centerlines of these holes extend perpendicularly to each other such that they intersect each other. In practice, the pins 17, 21 of the second and third couplings 15, 19 do not obstruct each other since it is not necessary to activate the second and third couplings 15, 19 at the same time. Similarly, the holes for receiving the pins 14, 24 of the first and fourth couplings 12, 22 are located at the same location of the piston rod 9 as seen in longitudinal direction of the hydraulic cylinder 7. Centerlines of these holes also extend perpendicularly to each other such that they intersect each other. Since it is not necessary to activate the first and fourth couplings 12, 22 at the same time the pins 14, 24 of the first and fourth couplings 12, 22 do not obstruct each other in practice.

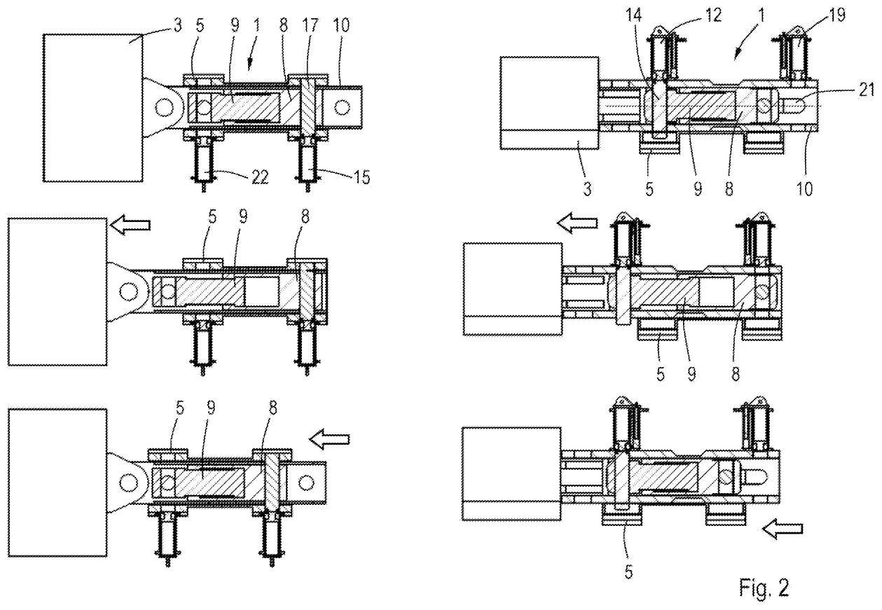

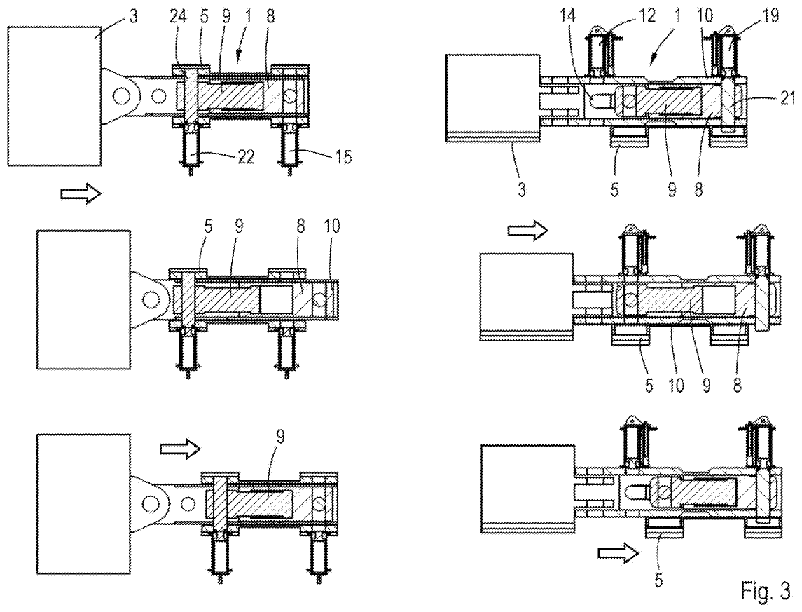

The skidding system 1 can be used for pushing the load 3, i.e. to the left in the situation as shown in FIG. 1, or for pulling the load 3, i.e. to the right in the situation as shown in FIG. 1. These operating modes are illustrated in FIGS. 2 and 3, respectively. In both figures the upper two pictures show a start condition in which the skid shoe 5 is locked to the skid rail 4 and the piston rod 9 is in a retracted position. The left picture shows a sectional view of the skidding system 1 in a horizontal plane and the right picture shows a sectional view of the skidding system 1 in a vertical plane.

Referring to FIG. 2, in case of pushing the load 3 the first and second couplings 12, 15 are in a coupled condition. This means that the piston rod 9 is mechanically coupled to the load 3 and the cylinder body 8 is mechanically coupled to the skid shoe 5. The third and fourth couplings 19, 22 are in a decoupled condition. When the skid shoe 5 is locked to the skid rail 4 and the hydraulic cylinder 7 is controlled such that the piston rod 9 is extended, the load 3 will be pushed by the hydraulic cylinder 7 and displaced together with the skid frame 10 with respect to the skid shoe 5. This is illustrated in the second row of pictures in FIG. 2. The movement of the skid frame 10 is allowed by the first and second slotted holes 18 in the side walls of the skid frame 10 through which the pin 17 of the second coupling 15 passes. In a next step the skid shoe 5 is unlocked with respect to the skid rail 4 and the hydraulic cylinder 7 is controlled such that the piston rod 9 is retracted. As a consequence, the skid shoe 5 is pulled towards the load 3, whereas the skid frame 10 remains at the same position with respect to the skid rail 4. This is illustrated in the lower row of pictures in FIG. 2. After the piston rod 9 has arrived in its retracted position the skid shoe 5 is locked again to the skid rail 4 and the cycle can be repeated in order to push the load step-by-step to the left.

Referring to FIG. 3, in case of pulling the load 3 the third and fourth couplings 19, 22 are in a coupled condition. This means that the cylinder body 8 is mechanically coupled to the load 3 and the piston rod 9 is mechanically coupled to the skid shoe 5. The first and second couplings 12, 15 are decoupled. When the skid shoe 5 is locked to the skid rail 4 and the piston rod 9 is in its retracted condition the hydraulic cylinder 7 is controlled such that the piston rod 9 is extended which means that the load 3 will be pulled by the cylinder body 8 of the hydraulic cylinder 7 and displaced together with the skid frame 10 with respect to the skid shoe 5. This is illustrated in the second row of pictures in FIG. 3. In a next step the skid shoe 5 is unlocked with respect to the skid rail 4 and the hydraulic cylinder 7 is controlled such that the piston rod 9 is retracted. As a consequence, the skid shoe 5 is pushed away from the load 3, whereas the skid frame 10 remains at the same position with respect to the skid rail 4. This is illustrated in the lower row of pictures in FIG. 3. After the piston rod 9 has arrived in its retracted position the skid shoe 5 is locked again to the skid rail 4 and the cycle can be repeated in order to pull the load step-by-step to the right.

FIGS. 2 and 3 make clear that both pushing and pulling of the load 3 is performed by controlling the hydraulic cylinder 7 such that the piston rod 9 extends. This is advantageous since pushing and pulling the load 3 requires more power than moving the skid shoe 5 with respect to the skid rail 4, whereas at a certain hydraulic pressure a higher force can be generated upon extending the piston rod 9 than retracting the piston rod 9. This is caused by the fact that due to the presence of the piston rod 9 a piston at the end of the piston rod 9 has a smaller surface on which hydraulic pressure is applied at the side of the piston rod 9 than at the opposite side of the piston. Consequently, the invention allows to apply a piston rod 9 which has a relatively large diameter with respect to the cylinder body 8.

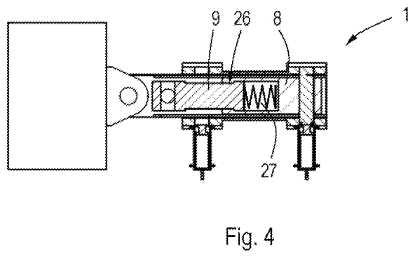

FIG. 4 illustrates an alternative embodiment of the skidding system 1 which is provided with a single acting hydraulic cylinder 26. In this case the hydraulic cylinder 26 comprises the cylinder body 8 and the piston rod 9. The piston rod 9 is also extendable with respect to the cylinder body 8 by hydraulic power in order to displace the load 3 with respect to the deck 2 in a direction along the line of displacement X when the skid shoe 5 is locked with respect to the skid rail 4, but the piston rod 9 is retractable with respect to the cylinder body 8 by a spring 27 instead of hydraulic power. The spring 27 forms a skid shoe displacement device for moving the skid shoe 5 in the same direction along the line of displacement when the skid shoe 5 is unlocked with respect to the skid rail 4. Under operating conditions when the piston rod 9 is extended with respect to the cylinder body 8 the spring 27 is biased, after which the hydraulic power to the hydraulic cylinder 26 is switched-off and the skid shoe 5 is unlocked with respect to the skid rail 4 such that the spring force of the biased spring 27 retracts the piston rod 9. Consequently, the skid shoe 5 moves in the same direction as the direction in which the load 3 has been moved. It is noted that the spring 27 may be located at a different location than shown in FIG. 4, as long as it is functionally coupled to the hydraulic cylinder 7 and the skid shoe 5 such that the spring 27 is biased upon extending the piston rod 9 with respect to the cylinder body 8. For example, the spring 27 may be coupled to the load 3 and the skid shoe 5.

The invention is not limited to the embodiment shown in the drawings and described hereinbefore, which may be varied in different manners within the scope of the claims and their technical equivalents. For example, the locations of the couplings may be different.

Although the present invention has been described with reference to preferred embodiments, workers skilled in the art will recognize that changes may be made in form and detail without departing from the spirit and scope of the invention.

What is claimed is:

1. A skidding system for skidding a heavy load over a deck of a vessel, comprising:
a skid shoe;
a skid rail configured to guide the skid shoe along a line of displacement;
a skid shoe lock configured to lock the skid shoe with respect to the skid rail;
a hydraulic cylinder configured to cooperate with the skid shoe and a load to be displaced with respect to the skid rail along the line of displacement, which hydraulic cylinder comprises a cylinder body and a piston rod that is extendable with respect to the cylinder body by hydraulic power so as to displace the load with respect to the skid rail in a direction along the line of displacement when the skid shoe is locked with respect to the skid rail;
a skid shoe displacement device configured to move the skid shoe in a same direction along the line of displacement when the skid shoe is unlocked with respect to the skid rail;
a first releasable coupling configured to couple the piston rod to the load to be displaced with respect to the skid rail along the line of displacement;
a second releasable coupling configured to couple the cylinder body to the skid shoe;
a third releasable coupling configured to couple the cylinder body to the load to be displaced with respect to the skid rail along the line of displacement; and
a fourth coupling configured to couple the piston rod to the skid shoe.

2. The skidding system according to claim 1, wherein each of the second and fourth couplings comprises a locking element and an actuator configured to activate the locking element, which actuator is mounted to the skid shoe.

3. The skidding system according to claim 2, wherein the locking elements of the second and fourth couplings comprise respective pins which are movable in their longitudinal directions by the corresponding actuators.

4. The skidding system according to claim 3, wherein the pin of the second coupling fits in cooperating holes of the skid shoe and the cylinder body, and wherein the pin of the fourth coupling fits in cooperating holes of the skid shoe and the piston rod.

5. The skidding system according to claim 1 further comprising a skid frame which is configured to be coupled to the load to be displaced with respect to the skid rail along the line of displacement, wherein each of the first and third couplings comprises a locking element and an actuator configured to activate the locking element, which actuator is mounted to the skid frame.

6. The skidding system according to claim 5, wherein the locking elements of the first and third couplings comprise respective pins which are movable in their longitudinal directions by the corresponding actuators.

7. The skidding system according to claim 6, wherein the pin of the first coupling fits in cooperating holes of the skid frame and the piston rod, and wherein the pin of the third coupling fits in cooperating holes of the skid frame and the cylinder body.

8. The skidding system according claim 7, wherein the pin of the second coupling fits in cooperating holes of the skid shoe and the cylinder body, and wherein the pin of the fourth coupling fits in cooperating holes of the skid shoe and the piston rod, wherein the holes for receiving the pins of the second and third couplings are located at a same location of the cylinder body as seen in longitudinal direction of the hydraulic cylinder and wherein the holes for receiving the pins of the first and fourth couplings are located at a same location of the piston rod as seen in longitudinal direction of the hydraulic cylinder.

9. The skidding system according to claim 8, wherein the holes at the piston rod intersect each other and/or the holes at the cylinder body intersect each other.

10. The skidding system according claim 7, wherein the pin of the second coupling fits in cooperating holes of the skid shoe and the cylinder body, and wherein the pin of the fourth coupling fits in cooperating holes of the skid shoe and the piston rod, wherein the skid frame surrounds the hydraulic cylinder and is supported by the skid shoe, wherein the skid frame is movable with respect to the skid shoe in the direction along the line of displacement and provided with slotted holes extending along the line of displacement for allowing a movement of the skid frame with respect to the skid shoe in an event that the pin of the second coupling is located in the corresponding hole in the skid shoe, the corresponding slotted hole in the skid frame and the corresponding hole in the cylinder body or in an event that the pin of the fourth coupling is located in the corresponding hole in the skid shoe, the corresponding slotted hole in the skid frame and the corresponding hole in the piston rod.

11. The skidding system according to claim 1, wherein the hydraulic cylinder is a double acting hydraulic cylinder, and wherein the piston rod is retractable with respect to the cylinder body by hydraulic power, hence forming the skid shoe displacement device.

12. The skidding system according to claim 1, wherein the skid shoe displacement device comprises a spring which is functionally coupled to the hydraulic cylinder and the skid shoe such that the spring is biased upon extending the piston rod with respect to the cylinder body.

13. A method of operating a skidding system for skidding a load over a deck of a vessel, the skidding system comprising a skid shoe, a skid rail configured to guide the skid shoe along a line of displacement, a skid shoe lock configured to lock the skid shoe with respect to the skid rail, a hydraulic cylinder, and first, second, third and fourth couplings, the method comprising:
coupling a piston rod of the hydraulic cylinder to the load using the first coupling and coupling a cylinder body of the hydraulic cylinder to the skid shoe using the second coupling;
configuring the third coupling to selectively couple the cylinder body to the load to be displaced with respect to the skid rail along the line of displacement, and configuring the fourth coupling to selectively couple the piston rod to the skid shoe, wherein the third and fourth couplings are left in de-coupled conditions; and
locking the skid shoe to the skid rail by the skid shoe lock when the piston rod is in a retracted condition, and then controlling the hydraulic cylinder such that the piston rod is extended so as to move the load with respect to the skid rail in a direction along the line of displacement, and subsequently the skid shoe lock is unlocked so as to move the skid shoe with respect to the skid rail in a same direction along the line of displacement by a skid shoe displacement device.

14. A method of operating a skidding system for skidding a load over a deck of a vessel, the skidding system comprising a skid shoe, a skid rail configured to guide the skid shoe along a line of displacement, a skid shoe lock configured to lock the skid shoe with respect to the skid rail, a hydraulic cylinder, and first, second, third and fourth couplings, the method comprising:
coupling a cylinder body of the hydraulic cylinder to the load using the third coupling and coupling a piston rod of the hydraulic cylinder to the skid shoe using the fourth coupling;
configuring the first coupling to selectively couple the piston rod of the hydraulic cylinder to the load, and configuring the second coupling to selectively couple the cylinder body of the hydraulic cylinder to the skid shoe, wherein the first and second couplings are left in de-coupled conditions; and
locking the skid shoe to the skid rail using the skid shoe lock when the piston rod is in a retracted condition, and then controlling the hydraulic cylinder such that the piston rod is extended so as to move the load with respect to the skid rail in a direction along the line of displacement, and subsequently the skid shoe lock is unlocked so as to move the skid shoe with respect to the skid rail in a same direction along the line of displacement by a skid shoe displacement device.
